(19) United States
(12) Patent Application Publication
(10) Pub. No.: US 2010/0209813 A1
(43) Pub. Date: Aug. 19, 2010

(54) BLOCK COPOLYMER, AND POLYMER ELECTROLYTE, POLYMER ELECTROLYTE MEMBRANE, MEMBRANE ELECTRODE ASSEMBLY AND FUEL CELL USING SAME

(76) Inventors: Atsuhiko ONUMA, Hitachi (JP); Makoto Morishima, Hitachinaka (JP); Naoki Asano, Tsukuba (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/707,094

(22) Filed: Feb. 17, 2010

(30) Foreign Application Priority Data
Feb. 17, 2009 (JP) 2009-33771

(51) Int. Cl. H01M 8/10; C08G 75/20; C08J 5/22

(52) U.S. Cl. 429/483; 528/391; 521/27

(57) ABSTRACT

A polymer electrolyte for a fuel cell is provided at low cost which has excellent mechanical characteristics, resistance to oxidation and high ion conductivity, and which hardly swells.

The polymer electrolyte includes a block copolymer containing a hydrophilic segment and a hydrophobic segment. The hydrophilic segment contains a structural unit represented by the following chemical formula (1).

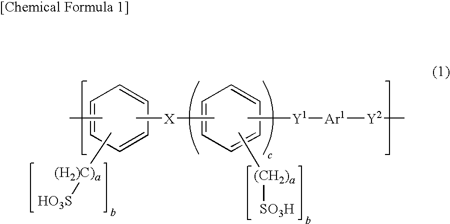

### CLAIM OF PRIORITY

The present application claims priority from Japanese Patent application serial No. 2009-33771, filed on Feb. 17, 2009, the content of which is hereby incorporated by reference into this application.

### BACKGROUND OF THE INVENTION

1. Field of the Invention

The present invention relates to a block copolymer, and a polymer electrolyte, a polymer electrolyte membrane, a membrane electrode assembly and a fuel cell using the same.

2. Description of Related Art

Fluorocarbon polymer electrolyte membranes having a high proton conductivity, such as Nafion® (registered trademark, manufactured by Dupont), Aciplex (registered trademark, manufactured by Asahi Kasei Chemicals Corporation), or Flemion (registered trademark, manufactured by Asahi Glass Co., Ltd.), are known as a polymer electrolyte membrane of a fuel cell.

Patent Literature 1 (Japanese Patent Laid-open No. 2003-31232) and Patent Literature 2 (Published Japanese Translation of PCT Patent Application No. 2006-512428) disclose a hydrocarbon polymer electrolyte membrane formed of a polyethersulfone block copolymer or a polyetherketone block copolymer.

Patent Literature 3 (Japanese Patent Laid-open No. 2005-216701) and Patent Literature 4 (Japanese Patent Laid-open No. 2005-353408) disclose a layer including a metal oxide serving as a hydrogen peroxide decomposition catalyst formed between an electrode catalyst layer and an electrolyte layer for suppressing degradation of the electrolyte membrane.

Patent Literature 5 (Japanese Patent Publication No. Hei 1-52866) discloses a membrane for a fuel cell having an excellent ion conductivity, and a measuring method of an exchange capacity (acid-base titration), the method being disclosed in the specifications.

### SUMMARY OF THE INVENTION

It is an object of the present invention to provide a block copolymer at a low cost having excellent mechanical characteristics, a resistance to oxidation and a high ion conductivity, and hardly swelling. It is another object of the present invention to provide a polymer electrolyte for a fuel cell, a polymer electrolyte membrane for a fuel cell, a membrane electrode assembly, and a fuel cell using the block copolymer.

A block copolymer of the present invention includes a structural unit represented by the following chemical formula (1).

In the formula, each of X, Y¹ and Y² is selected from the group consisting of a direct bond, —SO₂— and —CO—. The Y¹ and Y² may be the same or different, each of a and c is 0 or an integer number of 1 or more, and b is a rational number of 0 to 1 (including 0, 1, and a rational number between 0 and 1). Ar¹ is selected from the group consisting of functional groups represented by the chemical formulas (2) to (7). A substituent may be introduced into the chemical formulas (2) to (7). The substituent is selected from the group consisting of —C₆H₅, —OH, —Br, —Cl, —I, —CH₃ and —F.

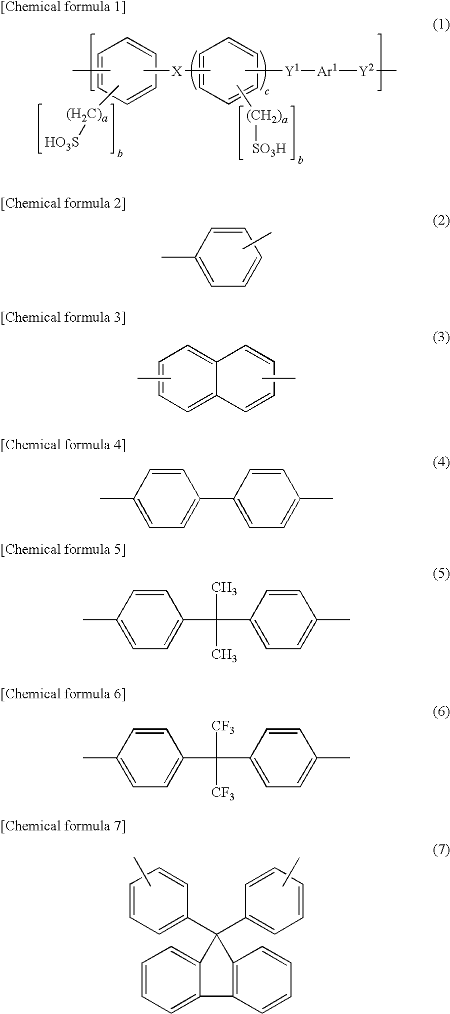

### BRIEF DESCRIPTION OF THE DRAWINGS

FIG. 1 is an exploded perspective view showing an internal structure of a fuel cell of an embodiment according to the present invention.

### DETAILED DESCRIPTION OF THE PREFERRED EMBODIMENTS

We have been dedicated themselves to finding a hydrocarbon polymer electrolyte membrane having excellent resistance to oxidation and excellent mechanical characteristics (including breaking elongation and the like).

As a result, an oxidation resistance test of electrolyte membranes using a polyethersulfone block copolymer or a polyetherketone block copolymer shows the following. That is, the number of sulfo groups of the electrolyte membrane obtained after the test is decreased, and the resistance to oxidation degradation of a hydrophilic segment of the block copolymer is lower than that of a hydrophobic segment thereof. The hydrophilic segment is decomposed and partially dissolved, and the hydrophilic segment is degraded sooner than the hydrophobic segment, thereby the entire polymer is degraded.

That is, we have found that the resistance to oxidation can be improved when a bond between aromatic rings of main chain structures of the hydrophilic segments has the great resistance to oxidation degradation.

Conventionally, it is thought that the resistance to oxidation of both the hydrophilic and hydrophobic segments must be improved. For this reason, the conventional electrolyte membrane includes a rigid polysulfone skeleton so as to obtain the adequate resistance to oxidation, but has problems in mechanical characteristics, including breaking elongation. Based on the findings, introduction of a unit having a curved structure into the hydrophobic segment can maintain the resistance to oxidation.

And it is found that the resistance of the electrolyte membrane is further improved by forming a cross-link between a part of an ion exchange group of the hydrophilic segments and the other hydrophilic segment or hydrophobic segment because the hydrophilic segments can exist as a component of the electrolytic membrane even after a part of the hydrophilic segments is oxidized and decomposed. The reason why the resistance to oxidation degradation of the hydrophilic segment is lower than that of the hydrophobic segment is not clear. However, this phenomenon is related to diffusion of hydrogen peroxide radicals in the electrolyte membrane, or a difference in electron density in the electrolyte.

As can be seen from the forgoing description, a polymer electrolyte membrane having excellent resistance to oxidation can be obtained by the use of the block copolymer including the hydrophilic and hydrophobic segments containing ion exchange groups. The hydrophilic segment contains a repeated structural unit represented by the following chemical formula (1). The hydrophobic segment contains an element represented by the following chemical formula (8) or (9).

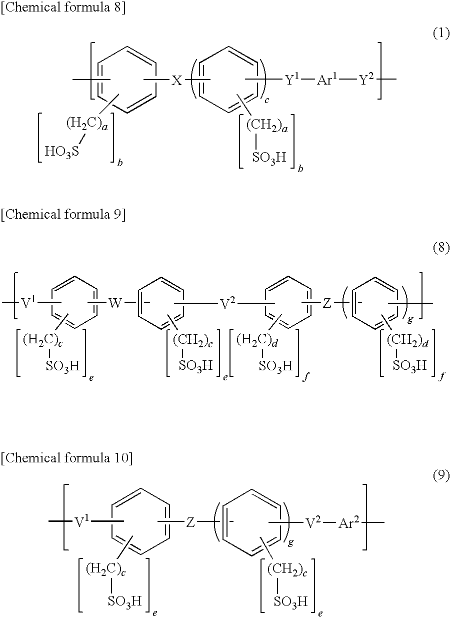

That is, the block copolymer of the present invention includes a structural unit which is the hydrophilic segment represented by the following chemical formula (1).

In the formula, each of X, Y¹ and Y² is selected from the group consisting of a direct bond, —SO₂, and —CO—. The Y¹ and Y² may be the same or different, each of a and c is 0 or an integer number of 1 or more, and b is a rational number of 0 to 1 (including 0, 1, and a rational number between 0 and 1). Ar¹ is selected from the group consisting of functional groups represented by the following chemical formulas (2) to (7). A substituent may be introduced to the functional groups represented by the following chemical formulas (2) to (7). The substituent is selected from the group consisting of —C₆H₅, —OH, —Br, —Cl, —I, —CH₃ and —F.

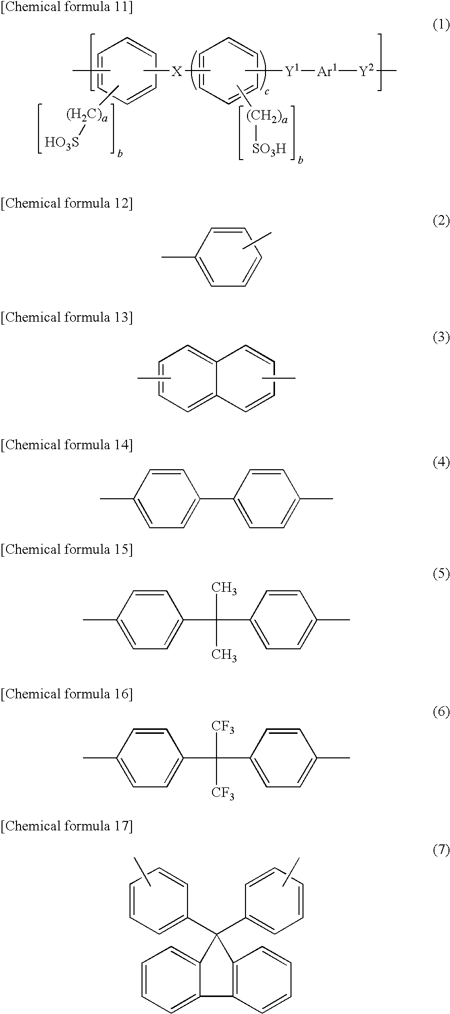

The term “direct bond” as used herein means a direct chemical bonding between adjacent atoms without a functional group in the chemical formula. For example, the above X, Y¹ and Y² do not have any functional group, such as —SO₂ — or —CO—, and carbon atoms (benzene rings) are directly bonded chemically to each other.

In the hydrophilic segment described above, a sulfa group in the above chemical formula (1) and a hydrogen atom or the like of a benzene ring in the above chemical formulas (2) to (7) undergo dehydration-condensation to form a cross-link between the hydrophilic segments.

Furthermore, the block copolymer of the present invention includes a structural unit which is the hydrophobic segment and which is represented by the following chemical formula (8).

In the formula, W is selected from the group consisting of a direct bond, —C(CH₃)₂—, —C(CF₃)₂—, —O—, —S— and a functional group represented by the above chemical formula (7). Z is of functional group selected from the group consisting of a direct bond, —SO₂— and —CO—. Each of the V¹ and V² is selected from the group consisting of a direct bond, —O— and —S—. The V¹ and V² may be the same or different. Each of c, d and g is 0 or an integer number of 1 or more, and each of e and f is a rational number of 0 to 1 (including 0, 1, and a rational number between 0 and 1).

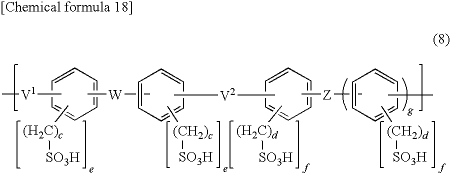

The block copolymer of the present invention includes a structural unit which is the hydrophobic segment and which is represented by the following chemical formula (9).

In the formula, Z is selected from the group consisting of a direct bond, —SO₂ and —CO—. Each of the V¹ and V² is selected from the group consisting of a direct bond, —O— and —S—. The V¹ and V² may be the same or different. Each of c and g is 0 or an integer number of 1 or more, and e is a rational number of 0 to 1 (including 0, 1, and a rational number between 0 and 1). Ar² is selected from the group consisting of functional groups represented by the following chemical formulas (10) to (14). A substituent may be introduced to the functional groups represented by the following chemical formulas (10) to (14). The substituent is selected from the group consisting of —C₆H₅, —OH, —Br, —Cl, —I, —CH₃, and —F. Each of Ar³ and Ar⁴ is a tetravalent group including at least one benzene ring.

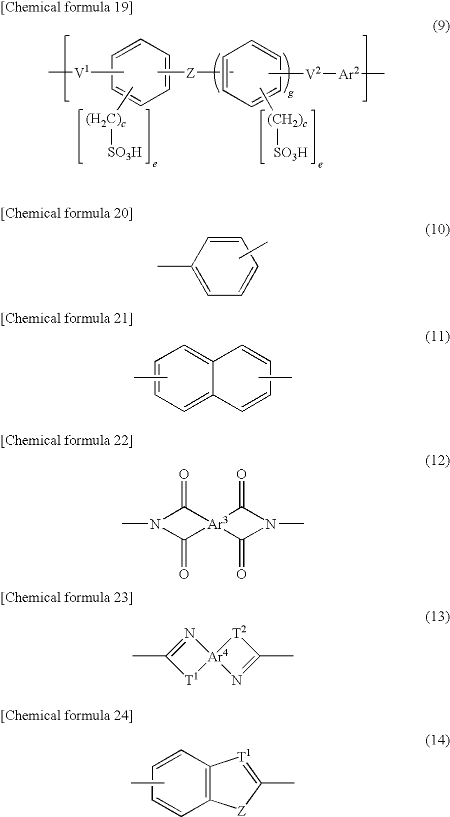

The term “tetravalent group having at least one benzene ring” is represented, for example, by the following chemical formulas (15) to (19). However, the present invention is not limited thereto.

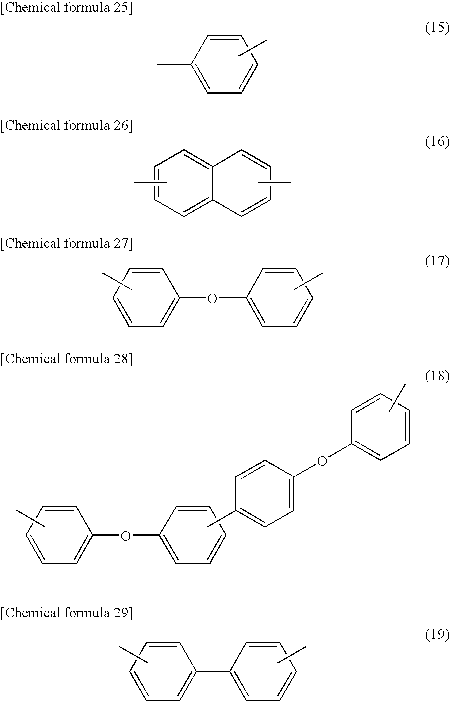

Each of T¹ and T² is selected from the group consisting of —O—, —S— and —NR—, where R is a hydrogen atom, an alkyl group having a carbon number of 1 to 6, an alkoxy group having a carbon number of 1 to 10, or an aryl group having a carbon number of 6 to 10. The alkyl group, alkoxy group and aryl group may have a substituent. The substituent is one selected from the group consisting of —C₆H₅, —OH, —Br, —I, —CH₃, and —F. The T¹ and T² may be the same or different.

The hydrophilic segment of the block copolymer of the present invention is soluble.

The block copolymer of the present invention has an ion exchange capacity of 0.3 to 5.0 meq/g.

The block copolymer of the present invention includes a three-dimensional cross-linked structure.

The polymer electrolyte for a fuel cell of the present invention uses the above-mentioned block copolymer.

The polymer electrolyte membrane for the fuel cell of the present invention uses the above-mentioned polymer electrolyte for the fuel cell.

The polymer electrolyte membrane for the fuel cell of the present invention preferably decreases its weight by 10% or less after the immersion into water, N-methylpyrrolidone, dimethylacetamide, dimethylformamide, dimethylsulfoxide, ethanol, methanol, or a mixture thereof at 80° C. for 24 hours.

The membrane electrode assembly of the present invention includes the above-mentioned polymer electrolyte membrane for the fuel cell, a cathode electrode and an anode electrode. The polymer electrolyte membrane for the fuel cell is interposed between the cathode electrode and the anode electrode.

The solid electrolyte fuel cell of the present invention uses the above-mentioned membrane electrode assembly.

The polymer electrolyte for the fuel cell of the present invention is applied to a polymer electrolyte fuel cell, called as PEFC, and a direct methanol fuel cell, called as DMFC. That is, the polymer electrolyte for the fuel cell of the present invention is applied to a polymer electrolyte membrane for the fuel cell, and further to a membrane electrode assembly, called as MEA.

The preferred embodiments of the present invention will be described below in detail.

The block copolymer included in the polymer electrolyte for the fuel cell of the present invention includes a hydrophilic segment and a hydrophobic segment. The hydrophilic segment includes a structural unit represented by the above chemical formula (1), and the hydrophobic segment includes a structural unit represented by the above chemical formula (8) or (9).

The block copolymer is a polymer having molecular structures (molecular chains), each including the same kind of monomers continuously coupled to each other among two or more kinds of monomers. That is, a polymer containing monomers A and B is a polymer having blocks (molecular structures), each including the respective monomers coupled to each other, like -A-A-A-A-A-B—B—B—B—.

The block copolymer of the present invention means a copolymer mainly containing at least one kind of hydrophilic segment and at least one kind of hydrophobic segment which are directly or indirectly coupled together by a covalent bonding. The block copolymer may be called as a block polymer. The block copolymer of the present invention may be one including the hydrophilic segment and the hydrophobic segment directly coupled together by reacting the hydrophilic segment at a Cl end group with the hydrophobic segment at an OH end group, like Example 1 (below-mentioned). Alternatively, the block copolymer may be one including a functional group existing between the hydrophilic segment and the hydrophobic segment produced by bonding the hydrophilic segment having an OH end group with the hydrophobic segment having the OH end group via the functional group.

The hydrophilic segment has an ion exchange capacity of 8 meq/g or more. The hydrophilic segment is a copolymer whose ion exchange capacity is more than that of the hydrophobic segment.

The hydrophilic segment has the large ion exchange capacity and an excellent proton conductivity (an ion conductivity). The formation of a cross-link between the hydrophilic segments improves the proton conductivity of the electrolyte membrane. Thus, it can be understood that the smaller frequency of separating the hydrophilic segments into the hydrophobic segments is, the more excellent proton conductivity the block copolymer (electrolyte membrane) has as the whole electrolyte membrane.

The structural unit of the hydrophilic segment of the polymer electrolyte for the fuel cell in the present invention does not have a group of —O— (ether group), and thus is hardly degraded. That is, the structural unit of the hydrophilic segment has an advantage that it is less likely to be oxidized.

The hydrophobic segment has an ion exchange capacity of less than 0.8 meq/g. The hydrophobic segment is a copolymer whose ion exchange capacity is smaller than that of the hydrophilic segment.

The structural unit of the hydrophobic segment of the polymer electrolyte for the fuel cell in the present invention may have —O— (ether group) or —S— (thioether group) added thereto, and thereby can give flexibility to the electrolyte membrane.

In a preferred embodiment, the hydrophobic segment and the hydrophilic segment are individually reacted, thus producing respective hydrophobic and hydrophilic segments, which are then polymerized. The present invention is not limited to this synthesizing method. For example, after synthesizing the hydrophobic-hydrophobic block copolymers, only one hydrophobic portion may be made hydrophilic by sulfuric acid, chlorosulfuric acid or the like.

The term “ion exchange capacity” means the number of ion exchange groups per unit weight of the polymer. The larger the ion exchange capacity is, the more the degree of introduction of the ion exchange groups are. The ion exchange capacity can be measured by a ¹H-NMR spectroscopy, an elemental analysis, a measuring method of an exchange capacity (an acid-base titration) disclosed in Patent Literature 5, a non-aqueous acid-base titration (a normal solution being benzene/methanol solution of potassium methoxide) and the like.

The hydrophilic segments used in the present invention include a sulfonated engineering plastic electrolyte, such as sulfonated polyketone, sulfonated polysulphone or sulfonated polyphenylene, and a hydrocarbon electrolyte, such as sulfoalkylated polyketone, sulfoalkylated polysulfone, sulfoalkylated polyphenylene, or a sulfoalkylated engineering plastic electrolyte.

The hydrophobic segments used in the present invention include an engineering plastic electrolyte, such as a polyetherketone copolymer, a polyetheretherketone copolymer, a polyethersulfone copolymer, a polyimide copolymer, polybenzimidazole copolymer, or a polyquinoline copolymer, and a substituent may be coupled thereto.

An analyzing method of the hydrophilic and hydrophobic segments of the block copolymer included in the polymer electrolyte for the fuel cell of the present invention involves dissolving a part of the hydrophilic segment in a solution by an oxidation resistance test, and respectively analyzing a dissolved material in the solution and an undissolved part of the electrolyte membrane by NMR, elemental analysis and the like.

The number average molecular weight of the block copolymer included in the polymer electrolyte for the fuel cell in the present invention is in a range of 10000 to 250000 in terms of the number average molecular weight of polystyrene by the GPC method, preferably in a range of 20000 to 220000, and more preferably in a range of 25000 to 200000. For the molecular weight less than 10000, the strength of the electrolyte membrane is reduced. For the molecular weight exceeding 250000, output performance is reduced. Both cases are not preferable.

The ion exchange capacity of the block copolymer included in the polymer electrolyte for the fuel cell of the present invention is 0.3 meq/g or more, and preferably 0.3 to 5.0 meq/g.

The block copolymer of the present invention is used in the state of a polymer membrane in the fuel cell.

Producing methods of the membrane include, for example, a solution casting method of forming the membrane in a solution state, a mold press casting method and an extrusion molding method. Among them, the solution casting method is preferable, and involves casting and applying a polymer solution to a substrate, and removing a solvent to form the membrane.

The solvent used in the above producing methods of the membrane is not limited to a specific one as long as it can be removed after the dissolution of the block copolymer of the present invention. For example, the solvents include aprotic polar solvent, such as N,N-dimethylformamide, N,N-dimethylacetamide, N-methyl-2-pyrolidone or dimethylsulfoxide, alkyleneglycolmonoalkylether, such as ethyleneglycolmonomethylether, ethyleneglycolmonoethylether, propyleneglycolmonomethylether or propyleneglycolmonoethylether, alcohol, such as iso-propylalcohol or t-butylalcohol, and tetrahydrofuran.

In producing the polymer electrolyte membrane of the present invention, additives, including a plasticizer, an antioxidant, hydrogen-peroxide decomposer, a metal trapping agent, a surfactant agent, a stabilizer, a parting agent and the like, which are normally used in the polymer, can be used without departing from the object of the present invention.

The antioxidants include an amine-based antioxidant, such as phenol-α-naphtylamine, phenol-β-naphtylamine, diphenylamine, p-hydroxydiphenylamine or phenothiazine, a phenol-based antioxidant, such as 2,6-di(t-butyl)-p-cresol, 2,6-di(t-butyl)-p-phenol, 2,4-dimethyl-6-(t-butyl)-phenol, p-hydroxyphenylcyclohexane, di-p-hydroxyphenylcyclohexane, styrenated phenol, or 1-1′-methylenebis(4-hydroxy-3,5-t-butylphenol), a sulfur-based antioxidant, such as dodecylmercaptan, dilaurylthiodipropionate, distearylthiodipropionate, dilaurylsulphide, or mercaptobenzoimidazole, and a phosphorus-based antioxidant, such as trinonylphenylphosphite, trioctadecylphosphite, tridecylphosphite or trilauryltrithiophosphite.

The hydrogen peroxide decomposer is not limited to a specific one as long as it has a catalytic action for decomposing a peroxide. For example, the hydrogen peroxide decomposers include, in addition to the above antioxidants, a metal, a metallic oxide, a metallic phosphate, a metallic fluoride, a macrocyclic metal complex and the like. One kind selected from the group of these hydrogen peroxide decomposers may be singly used, or two or more kinds selected from the group may be used together. Among them, suitable metals include Ru, Ag and the like. Suitable metal oxides include RuO, WO₃, CeO₂, Fe₃O₄ and the like. Suitable metallic phosphates include CePO₄, CrPO₄, AlPO₄, FePO₄ and the like. Suitable metallic fluorides include CeF₃, FeF₃ and the like. Suitable macrocyclic metal complexes include Fe-porphyrin, Co-porphyrin, hem, catalase and the like. In particular, RuO₂ or CePO₄ may be preferably used because of a high decomposition property of the peroxide.

The metal trapping agent is not limited to a specific one as long as it is reacted with metallic ions, such as Fe²⁺ or Cu²⁺, to form a complex thereby to inactivate the metallic ions, thus preventing acceleration of degradation of the metallic ions. Such metal trapping agents include thenoyltrifluoroacetone, sodium diethyldithiocarbamate (DDTC), 1,5-diphenyl-3-thiocarbazone, or a crown ether, such as 1,4,7,10,13-pentaoxycyclopentadecane or 1,4,7,10,13,16-hexaoxycyclopentadecane, and a cryptand, such as 4,7,13,16-tetraoxa-1,10-diazacyclooctadecane or 4,7,13,16,21,24-hexaoxy-1,10-diazacyclohexacosane, and a porphyrin-based material such as tetra-phenyl porphyrin. The amount of a mixture of these materials is not limited to one disclosed in the embodiment of the present invention. Among them, a mixture of the phenol-based antioxidant and the phosphorus-based antioxidant is preferable because the mixture is effective even in a small amount and little adversely affects the characteristics of the fuel cell.

The antioxidant, the hydrogen peroxide decomposer and the metal trapping material may be added to the electrolyte membrane or electrode, and be disposed between the membrane and electrode. In particular, such materials are preferably disposed in the cathode electrode or between the cathode electrode and the electrolyte membrane because they can exhibit the respective effects even in the small amounts and little adversely affect the characteristics of the fuel cell.

The thickness of the polymer electrolyte membrane of the present invention is not limited to a specific one, but is preferably in a range of 10 to 300 μm, and in particular, more preferably in a range of 15 to 200 μm. In order to obtain the strength of the membrane sufficient for the practical use, the thickness is preferably 10 μm or more. In order to reduce the resistance of the membrane, that is, to improve an electric generation performance, the thickness is preferably 300 μm or less.

In the solution casting method, the thickness of the above material can be controlled by the concentration of the solution or the thickness of application of the material to a substrate. In forming the membrane in the melted state, the thickness can be controlled by extending the membrane at a predetermined magnification, the membrane obtained in a predetermined thickness by the mold press casting method or extrusion molding method.

The electrolyte membrane produced by a cross-link of the polymer electrolyte membrane also falls within the scope of the present invention. The cross-link of the electrolyte membrane includes a cross-link using a phenol-based cross-linking material, and a cross-link performed by dehydration-condensation between a sulfa group of the hydrophilic segment and a hydrogen of a benzene ring.

In the present invention, the above polymer electrolyte membrane preferably decreases its weight by 10% or less after the immersion into water, N-methylpyrrolidone, dimethylacetamide, dimethylformamide, dimethyl sulfoxide, ethanol or methanol, or a mixture thereof at 80° C. for 24 hours.

A polymer electrolyte which can conduct protons is used as an element of a binder. Therefore, the polymer electrolyte of the present invention, and a conventional fluorinated polymer electrolyte or hydrocarbon electrolyte can be used as the element of the binder. The element of the binder is used as an adhesive for bonding the polymer electrolyte membrane to an electrode, or an adhesive for connecting carbon powders carrying a catalyst in the electrode.

The above hydrocarbon electrolytes include, for example, a sulfonated engineering plastic electrolyte, such as sulfonated polyetheretherketone, sulfonated polyethersulfone, sulfonated acrylonitrile-butadiene-styrene polymer, sulfonated polysulfide or sulfonated polyphenylene, a sulfoalkylated engineering plastic electrolyte, such as sulfoalkylated polyetheretherketone, sulfoalkylated polyethersulfone, sulfoalkylated polyetherethersulfone, sulfoalkylated polysulfone, sulfoalkylated polysulfide, sulfoalkylated polyphenilene or sulfoalkylated polyetherethersulfone, a hydrocarbon electrolyte such as sulfoalkyletherified polyphenylene, and a hydrocarbon polymer having an adequate proton conductivity and an resistance to oxidation.

The anode catalyst and the cathode catalyst may be any other metal for promoting an oxidation of the fuel and a reduction of oxygen. For example, suitable materials for the catalyst include platinum (Pt), gold (Au), silver (Ag), palladium (Pd), iridium (Ir), rhodium (Rh), ruthenium (Ru), iron (Fe), cobalt (Co), nickel (Ni), chrome (Cr), tungsten (W), manganese (Mn), vanadium (V), titanium (Ti), and an alloy thereof. Among these catalysts, platinum (Pt) is used in many cases. The grain size of the metal serving as catalyst is normally in a range of 1 to 30 nm. Such catalysts attached to a carrier of carbon or the like require less amount of use of the catalyst, which is advantageous in terms of the cost. The amount of catalyst carried is preferably in a range of 0.01 to 20 mg/cm² in the state that an electrode is formed.

The electrode used for the membrane electrode assembly comprises a conductive material carrying fine particles of the catalyst metal. The electrode may contain a water repellent or binder, if necessary. A layer including the conductive material not carrying the catalyst, and the water repellent and/or binder included therein if necessary may be formed outside the catalyst layer. The conductive metal for carrying the catalyst metal is any other material serving as electron conductive material, and includes, for example, various metals and carbon materials.

For example, a carbon black, such as a furnace black, a channel black or an acetylene black, a fibrous carbon such as a carbon nanotube, an activated carbon or graphite can be used as the carbon material. A single one of these materials or a mixture thereof can be used.

As the water repellent, for example, a fluorinated carbon or the like is used. A hydrocarbon electrolyte solution having the same type of the electrolyte membrane is used as a binder, which is preferable from the viewpoint of bonding. However, various other resins maybe used. A fluorocarbon resin having water repellency, for example, polytetrafluoroethylene, tetrafluoroethylene-perfluoroalkylvinylether copolymer, and tetrafluoroethylene-hexafluoropropylene copolymer may be added.

A method for bonding the polymer electrolyte membrane to the electrode for the use of the fuel cell is not limited to a specific one, and a well known method can be used therefor.

For example, a method for producing a membrane electrode assembly involves using a carbon carrying a Pt catalyst powder as a conductive material, mixing the carbon into a polytetrafluoroethylene suspension to apply the mixture to a carbon paper, and applying a thermal treatment to the carbon paper to form a catalyst layer.

Then, the method further involves applying a solution including a polymer electrolyte which is the same material as that of the polymer electrolyte membrane as a solute, or a solution of a fluorinated electrolyte as the binder to a catalyst layer, and integrating the catalyst layer with the polymer electrolyte membrane by a hot press.

Other methods for producing the membrane electrode assembly include a method for previously coating a polymer electrolyte solution with a Pt catalyst powder, and a method for applying a catalyst paste to the polymer electrolyte membrane by a printing method, a spray method or an ink jet method, an electroless plating method for electrolessly plating the electrode on the polymer electrolyte membrane, and a method for absorbing platinum group metal complex ions into the polymer electrolyte membrane and thereafter reducing the polymer electrolyte membrane. Among them, the method for applying the catalyst paste to the polymer electrolyte membrane by the inkjet method is excellent with little loss of the catalyst.

In the present invention, the use of the above block copolymer for the electrolyte membrane can provide fuel cells having various forms.

For example, a single cell of a polymer electrolyte fuel cell can be formed, in which the polymer electrolyte membrane is interposed between an oxygen electrode formed on one main surface of the electrolyte membrane and a hydrogen electrode formed on the other surface thereof to form the electrolyte membrane/electrodes assembly, gas diffusion sheets are respectively stuck on the oxygen and hydrogen electrode sides of the electrolyte membrane/electrodes assembly, and conductive separators having gas supply flow paths to the oxygen electrode and hydrogen electrode are provided on outer surfaces of the gas diffusion sheets.

Further, a portable power supply can be provided which accommodates the above fuel cell body and a hydrogen cylinder for storing hydrogen to be supplied to the fuel cell body in a case.

Moreover, the fuel cell power generation device can be provided which includes a reformer for reforming a fuel into anode gas containing hydrogen, the above fuel cell for generating electricity using the anode gas and a cathode gas containing oxygen, and a heat exchanger for exchanging heat between the high-temperature anode gas discharged from the reformer and a low-temperature fuel gas supplied to the reformer.

Furthermore, a single cell of a direct methanol fuel cell can be formed which includes an electrolyte membrane/electrodes assembly formed by interposing the polymer electrolyte membrane between an oxygen electrode and a methanol electrode, gas diffusion sheets respectively stuck on the oxygen and methanol electrode sides of the electrolyte membrane/electrodes assembly, and conductive separators having gas and liquid supply flow paths to the oxygen electrode and methanol electrode on outer surfaces of the gas diffusion sheets.

The following will further describe the embodiments of the present invention in more detail with reference to examples.

It is understood that the feature of the present invention is not limited only to the examples disclosed herein.

### Example 1

### (1) Producing of Polymer a (Hydrophobic Segment)

A four-neck round-bottomed flask having a capacity of 300 ml (milliliter) was provided with a reflux condenser having a stirrer, a thermometer and a drying tube containing a calcium chloride connected thereto. The inside of the flask was substituted by nitrogen. Then, 4,4-dichlorodiphenylsulfone, 4,4-biphenol and potassium carbonate were prepared and introduced into the flask at a mol ratio of 1.00:1.05:1.15. The reaction was performed at 200° C. for 24 hours using toluene as an azeotropic agent and N-methyl-2-pyrolidone (NMP) as solvent thereby to form a polymer with OH end groups.

The molecular weight (determined by the GPC in terms of polystyrene) of the obtained hydrophobic segment was measured. The number average molecular weight Mn was 2.0×10⁴, and the weight-average molecular weight Mw thereof was 4.4×10⁴.

Measuring conditions for a gel permeation chromatography (GPC) were as follows.

GPS device: HLC-8220GPC manufactured by Tosoh corporation

Column: two pieces of TSKgel Super AWM-H manufactured by Tosoh corporation

Eluent: N-methyl-2-pyrolidone (NMP, to which 10 mmol/L (millimol per liter) of a lithium-bromide solution is added)

### (2) Producing of Polymer b (Hydrophilic Segment)

A four-neck round-bottomed flask having a capacity of 1000 ml was provided with a reflux condenser having a stirrer, a thermometer and a drying tube containing a calcium chloride connected thereto. The inside of the flask was substituted by nitrogen. Then, sulfonated 4,4-dichlorodiphenylsulfone, 4,4-thiobisbenzenethiol and potassium carbonate were prepared and introduced into the flask at a mol ratio of 1.05:1.00:1.15. The reaction was performed at 200° C. for 12 hours using a mixture of toluene, dimethyl sulphoxide (DMSO) and N-methyl-2-pyrolidone (NMP) as a solvent thereby to form a polymer with Cl (chlorine) end groups. The number average molecular weight Mn of the hydrophilic segment was 3.6×10⁴, and the weight-average molecular weight Mw thereof was 8.0×10⁴.

### (3) Producing of Block Copolymer (A)

The polymer (a) and polymer (b) synthesized by the above processes (1) and (2) were mixed together to be reacted with each other at 200° C. for 10 hours. The mixing ratio of the polymer (a) to the polymer (b) was adjusted in such a manner that an ion exchange capacity was 2.0 meq/g. The obtained solution was introduced into water and was precipitated again, whereby a block copolymer (A) was obtained. The number average molecular weight Mn of the obtained block copolymer (A) was 1.2×10⁵, and the weight-average molecular weight Mw thereof was 4.7×10⁵. The ion exchange capacity measured by the acid-base titration was 1.9 meq/g.

### (4) Producing of Polymer Electrolyte Membrane and Properties Thereof

The block copolymer (A) obtained in the above process (3) was dissolved in n-methylpyrrolidone (NMP) at a concentration of 15% by weight. The solution was casted and applied to the glass, and then heated and dried. The glass obtained was immersed in sulfuric acid and water, and dried to obtain a polymer electrolyte membrane of 40 μm in thickness. Thioether bonds of the polymer electrolyte membrane were oxidized by the method disclosed in Non-Patent Literature 1 (Polymer. Preprints, Japan, vol. 55, No. 1, p. 1426 (2006)) to be all converted to sulfonyl bonds, so that a polymer electrolyte membrane was obtained.

The ratio of change in a size about an area of a large surface of the polymer electrolyte membrane after the immersion in water at 80° C. for 8 hours was 3%. The ion conductivity of the membrane at 10 KHz measured by a four-terminal AC impedance is method at 80° C. for 60 RH % was 7.0×10⁻² S/cm.

As the oxidation resistance test, a Fenton test was performed which involved immersing the polymer electrolyte membrane into 3% H₂O₂ solution containing 3 ppm of Fe²⁺ at 80° C. for 90 minutes. The weight residual ratio of the membrane after the Fenton test was 95%.

### (5) Producing of Cross-Linked Polymer Electrolyte Membrane and Properties Thereof

Cross-links are formed by the method disclosed in the Non-Patent Literature 1 in the polymer electrolyte membrane manufactured by the above process (4), whereby a cross-linked polymer electrolyte membrane was obtained.

The ratio of change in a size about an area of a large surface of the polymer electrolyte membrane in the direction of area after the immersion in water at 80° C. for 8 hours was 0%. The ion conductivity of the membrane at 10 KHz measured by the four-terminal AC impedance method at 80° C. for 60 RH % was 6.3×10⁻² S/cm. As the oxidation resistance test, a Fenton test was performed which involved immersing the above cross-linked polymer electrolyte membrane into 3% H₂O₂ solution containing 3 ppm of Fe²⁺ at 80° C. for 90 minutes. The weight residual ratio of the membrane after the Fenton test was 97%.

### (6) Producing of Membrane Electrode Assembly (MEA)

Catalyst powder including 70% by weight of platinum fine particles dispersed and carried on a carbon carrier and 5% by weight of poly (perfluorosulfonic acid) were mixed in a mixed solvent of 1-propanol, 2-propanol and water to prepare a slurry. The slurry was applied on the above polymer electrolyte membrane by spray such that the weight of catalyst was 0.4 g/cm² thereby to produce a cathode and an anode, each having a thickness of about 20 μm, a width of 30 mm, and a length of 30 mm. Thereafter, pressing thermally was performed at 120° C. and 130 MPa, thus producing a membrane electrode assembly (MEA) having the anode and cathode formed on both sides of the above polymer electrolyte membrane.

### (7) Power Generation Performance of Fuel Cell (PEFC)

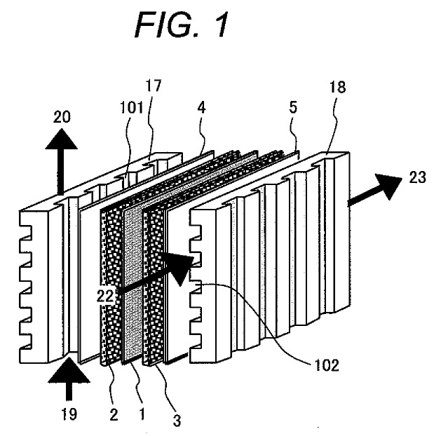

FIG. 1 is an exploded perspective view showing the internal structure of the fuel cell according to the present invention.

In the figure, the fuel cell includes a polymer electrolyte membrane 1, an anode electrode 2, a cathode electrode 3, an anode diffusion layer 4, a cathode diffusion layer 5, an anode-side separator 17, and a cathode-side separator 18. These elements are assembled by sticking each other to form a single cell. The single cell is provided with a fuel flow path 101 and an air flow path 102.

In the figure, hydrogen 19 is allowed to flow through the fuel flow path 101, and air 22 is allowed to flow through the air flow path 102. Electrons are deprived the hydrogen molecules 19 (the hydrogen molecules 19 are oxidized) while the hydrogen molecules 19 passing through the fuel flow path 101 to be converted into protons (H⁺), which diffuse inside the polymer electrolyte membrane 1 and react with oxygen molecules contained in the air 22 passing through the air flow path 102 to form water. FIG. 1 shows a reaction residue (hydrogen and water vapor) 20, and air 23 containing water vapor.

The power generation performance of the above MEA using the compact single cell shown in the figure was measured.

In this measurement, the single cell was disposed in a thermostatic bath, and the temperature of the thermostatic bath was controlled such that the temperature of the thermocouples (not shown) disposed in the anode-side separator 17 and the cathode-side separator 18 was 70° C.

The anode and cathode were humidified using a humidifier disposed outside the single cell. The temperature of the humidifier was controlled to be in a range of 70 to 73° C. in such a manner that the dew point near an exit of the humidifier was 70° C. Electricity was generated at a density of load current of 250 mA/cm², a hydrogen utilization of 70%, and an air utilization of 40% . As a result, it has been found that the above-mentioned single cell outputs a voltage of 0.74 V or more and can stably generate electricity for 500 hours or more.

### Example 2

### (1) Producing of Polymer (c) (Hydrophilic Segment)

In the same way as that described in the process (2) of Example 1, sulfonated 4,4-difluorobenzophenone, 4,4-biphenol and potassium carbonate were prepared and introduced into the flask at a mol ratio of 1.05:1.00:1.15. The reaction was performed at 200° C. for 12 hours using a mixed solvent of toluene, dimethyl sulfoxide (DMSO) and N-methyl-2-pyrolidone (NMP) to synthesize a polymer (c) with F end groups.

The number average molecular weight Mn of the hydrophilic segment was 3.8×10⁴, and the weight-average molecular weight Mw thereof was 5.5×10⁴.

### (2) Producing of Block Copolymer (B)

The polymer (c) and the polymer (a) synthesized in the process (1) of Example 2 and Example 1(1) in the same way as that described in the process (3) of Example 1 were mixed and reacted with each other at 200° C. for 10 hours. The mixing ratio of the polymer (c) to the polymer (a) was adjusted such that the ion exchange capacity was 2.0 meq/g. The solution obtained was introduced into water and precipitated again thereby to obtain a block copolymer (B).

The number average molecular weight Mn of the block copolymer (B) obtained was 1.3×10⁵, and the weight-average molecular weight Mw thereof was 4.0×10⁵. The ion exchange capacity measured by the acid-base titration was 1.8 meq/g.

### (3) Producing of Polymer Electrolyte Membrane and Properties Thereof

In the same way as that described in the process (4) of Example 1, the polymer electrolyte membrane was obtained from the above block copolymer (B). The ratio of change in a size about an area of a large surface of the polymer electrolyte membrane after the immersion in water at 80° C. for 8 hours was 4%. The ion conductivity of the membrane at 10 KHz measured by the four-terminal AC impedance method at 80° C. for 60 RH % was 5.0×10⁻²S/cm. As the oxidation resistance test, a Fenton test was performed which involved immersing the polymer electrolyte membrane into 3% H₂O₂ solution containing 3 ppm of Fe²⁺ at 80° C. for 90 minutes. The weight residual ratio of the membrane after the Fenton test was 96%.

### (4) Producing of Cross-Linked Polymer Electrolyte Membrane and Properties Thereof

A cross-link was formed in the polymer electrolyte membrane manufactured by the process (3) of Example 2 in the same way as that disclosed in the process (5) of Example 1 thereby to obtain a cross-linked polymer electrolyte membrane. The ratio of change in a size about an area of a large surface of the polymer electrolyte membrane after the immersion in water at 80° C. for 8 hours was 0%. The ion conductivity of the membrane at 10 KHz measured by the four-terminal AC impedance method at 80° C. for 60 RH % was 4.2×10⁻²S/cm. As the oxidation resistance test, a Fenton test was performed which involved immersing the polymer electrolyte membrane into 3% H₂O₂ solution containing 3 ppm of Fe²⁺ at 80° C. for 90 minutes. The weight residual ratio of the membrane after the Fenton test was 99%.

### (5) Producing of Membrane Electrode Assembly (MEA)

In the same way as that described in the process (6) of Example 1, a MEA was obtained from the polymer electrolyte membrane obtained in the process (4) of Example 2.

### (6) Power Generation Performance of Fuel Cell (PEFC)

A battery performance of the PEFC using the MEA obtained in the process (6) of Example 2 was measured in the same way as that described in the process (7) of Example 1. The PEFC using the MEA showed an output of 0.73 V or more, and can stably generate electricity for 800 hours or more.

### Comparative Example 1

### (1) Producing of Polymer (d) (Hydrophobic Segment)

A four-neck round-bottomed flask having a capacity of 1000 ml was provided with a reflux condenser having a stirrer, a thermometer and a drying tube containing a calcium chloride connected thereto. The inside of the flask was substituted by nitrogen. Then, sulfonated 4,4-dichlorodiphenylsulfone, 4,4-biphenol and potassium carbonate were prepared and introduced into the flask at a mol ratio of 1.00:1.05:1.15. The reaction was performed at 200° C. for 24 hours using toluene as an azeotropic agent and N-methyl-2-pyrolidone (NMP) as a solvent thereby to synthesize a polymer with OH end groups. Further, decafluorobiphenyl was added thereto at a mol ratio of 0.1, thereby changing all end groups into F.

The number average molecular weight Mn of the hydrophobic is segment obtained was 2.0×10⁴, and the weight-average molecular weight Mw thereof was 4.4×10⁴.

### (2) Producing of Polymer (e) (Hydrophilic Segment)

A four-neck round-bottomed flask having a capacity of 1000 ml was provided with a reflux condenser having a stirrer, a thermometer and a drying tube containing a calcium chloride connected thereto. The inside of the flask was substituted by nitrogen. Then, sulfonated 4,4-dichlorodiphenylsulfone, 4,4-biphenol and potassium carbonate were prepared and introduced into the flask at a mol ratio of 1.60:1.65:1.15. The reaction was performed 200° C. for 12 hours using toluene and N-methyl-2-pyrolidone (NMP) as a solvent thereby to synthesize a polymer with OH end groups. The number average molecular weight Mn of the hydrophilic segment was 3.5×10⁴, and the weight-average molecular weight Mw thereof was 8.5×10⁴.

### (3) Producing of Block Copolymer (C)

The polymer (d) and the polymer (e) synthesized in Comparative the processes (1) and (2) of Comparative Example were mixed and reacted with each other at 140° C. for two hours. The ratio of mixing of the polymer (d) to the polymer (e) was adjusted such that an ion exchange capacity was 2.0 meq/g. The thus-obtained solution was introduced into water and precipitated again thereby to obtain a block copolymer (C).

The number average molecular weight Mn of the thus-obtained block copolymer (C) was 1.2×10⁵, and the weight-average molecular weight Mw thereof was 4.7×10⁵. An ion exchange capacity measured by the acid-base titration was 1.8 meq/g.

### (4) Producing of Polymer Electrolyte Membrane and Properties Thereof

A polymer electrolyte membrane was obtained from the block copolymer (C) in the same way as that of the process (4) of Example 1. The ratio of change in a size about an area of a large surface of the polymer electrolyte membrane after the immersion in water at 80° C. for 8 hours was 13%. The ion conductivity of the membrane at 10 KHz measured by the four-terminal AC impedance method at 80° C. for 60 RH % was 7.0×10⁻² S/cm. As the oxidation resistance test, the Fenton test was performed which involved immersing the polymer electrolyte membrane into 3% H₂O₂ solution containing 3 ppm of Fe²⁺ at 80° C. for 90 minutes. The weight residual ratio of the membrane after the Fenton test was 18%.

### (5) Producing of Cross-Linked Polymer Electrolyte Membrane and Properties Thereof

A cross-link was formed in the polymer electrolyte membrane in the same way as that of the process (5) of Example 1 to obtain a cross-linked polymer electrolyte membrane. The ratio of change in a size about an area of a large surface of the polymer electrolyte membrane after the immersion in water at 80° C. for 8 hours was 12%. The ion conductivity of the membrane at 10 KHz measured by the four-terminal AC impedance method at 80° C. for 60 RH % was 6.8×10⁻² S/cm.

As the oxidation resistance test, the Fenton test was performed which involved immersing the cross-linked polymer electrolyte membrane into 3% H₂O₂ solution containing 3 ppm of Fe²⁺ at 80° C. for 90 minutes. The weight residual ratio of the membrane after the Fenton test was 35%.

As described above, the comparison of Examples 1 and 2 with Comparative Example 1 shows that the cross-linked polymer electrolyte membrane of Examples 1 and 2 according to the present invention has more excellent oxidation resistance and mechanical strength than that of Comparative Example 1.

According to the present invention, the low-cost block copolymer can be provided which has excellent mechanical characteristics, a resistance to oxidation and a high ion conductivity, and which hardly swells. Further, the polymer electrolyte for a fuel cell, the polymer electrolyte membrane for the fuel cell, the membrane electrode assembly, and the fuel cell using the above block copolymer can be provided. Thus, the lifetime of the fuel cell can be improved.

Since a block copolymer according to the present invention does not necessarily contain fluorine (F), it does not generate hydrofluoric acid in burning for disposal. Further, since an electrolyte membrane including the block copolymer keeps a high is ion conductivity at high temperature, the electrolyte membrane can be used at high temperature. Further, reduction in voltage or power generating efficiency due to a methanol crossover in a direct methanol fuel cell (DMFC) can be prevented.

Moreover, according to the present invention, a small ion conduction resistance of the electrolyte membrane can be obtained and processes for producing the electrolyte membrane become simple since a small amount of additives introduce to the electrolyte membrane. And thereby, a cost for producing the electrolyte membrane can be reduced.

The present invention can provide the polymer electrolyte membrane for the fuel cell with excellent mechanical strength and resistance to water, and thus can be used in a direct methanol fuel cell, a polymer fuel cell and the like.

What is claimed is:

1. A block copolymer containing a structural unit represented by the following chemical formula (1): 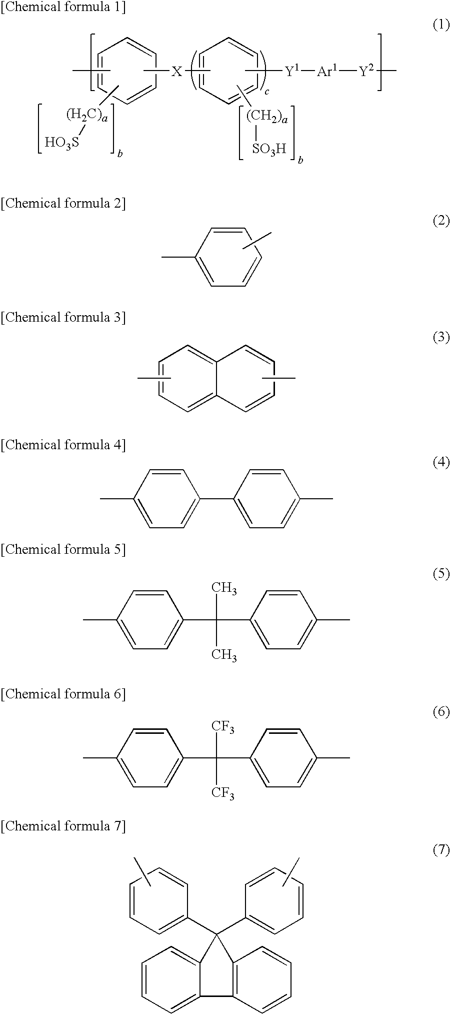
where each of X, Y¹ and Y² is selected from the group consisting of a direct bond, —SO₂— and —CO—, each of Y¹ and Y² may be the same or different, each of a and c is 0 or an integer number of 1 or more, and b is a rational number of 0 to 1, and
where Ar¹ is selected from the group consisting of functional groups represented by chemical formulas (2) to (7),
wherein a substituent maybe introduced into the chemical formulas (2) to (7), the substituent being selected from the group consisting of —C₆H₅, —OH, —Br, —Cl, —I, —CH₃ and —F.

2. The block copolymer according to claim 1, containing a structural unit represented by the following chemical formula (8): 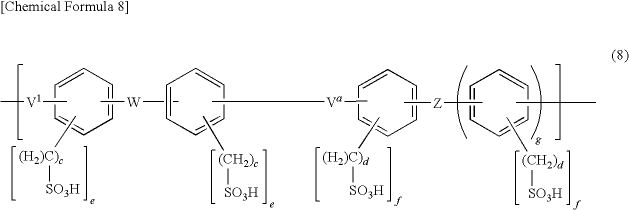
where W is selected from the group consisting of a direct bond, —C(CH₃)₂—, —C(CF₃)₂—, —O—, —S— and a functional group represented by the chemical formula (7), Z is of functional group selected from the group consisting of a direct bond, —SO₂— and —CO—, each of the V¹ and V² is selected from the group consisting of a direct bond, —O— and —S—, and the V¹ and V² may be the same or different, and
where each of c, d and g is 0 or an integer number of 1 or more, and each of e and f is a rational number of 0 to 1.

3. The block copolymer according to claim 1, containing a structural unit represented by the following chemical formula (9): 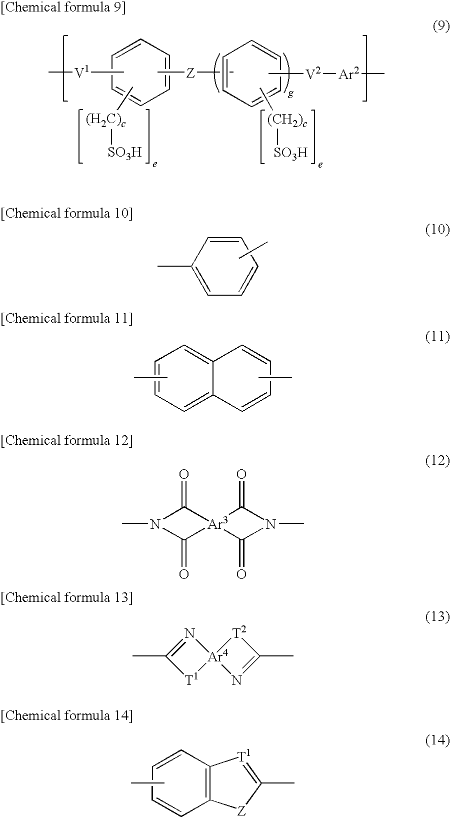
where Z is selected from the group consisting of a direct bond, —SO₂— and —CO—, each of V¹ and V² is selected from the group consisting of a direct bond, —O— and —S—, and the V¹ and V² may be the same or different, each of c and g is 0 or an integer number of 1 or more, and e is a rational number of 0 to 1, and
where Ar² is selected from the group consisting of functional groups represented by the chemical formulas (10) to (14),
where a substituent maybe introduced into the functional groups represented by the chemical formulas (10) to (14), the substituent being selected from the group consisting of —C₆H₅, —OH, —Br, —Cl, —I, —CH₃ and —F,
where each of Ar³ and Ar⁴ is a tetravalent group including at least one benzene ring, and
where each of T¹ and T² is selected from the group consisting of —O—, —S— and —NR—, the R being a hydrogen atom, an alkyl group having a carbon number of 1 to 6, an alkoxy group having a carbon number of 1 to 10, or an aryl group having a carbon number of 6 to 10, and
where the alkyl group, alkoxy group, and aryl group may have a substituent, the substituent being one selected from the group consisting of —C₆H₅, —OH, —Br, —I, —CH₃ and —F, and the T¹ and T² may be the same or different.

4. The block copolymer according to claim 1, wherein the structural unit represented by the chemical formula (1) is a hydrophilic segment, the hydrophilic segment being soluble.

5. The block copolymer according to claim 1, wherein an ion exchange capacity is in a range of 0.3 to 5.0 meq/g.

6. The block copolymer according to claim 4, wherein the block copolymer has a three-dimensional cross-linked structure.

7. The block copolymer according to claim 5, wherein the block copolymer has a three-dimensional cross-linked structure.

8. A polymer electrolyte for a fuel cell comprising the block copolymer according to claim 1.

9. A polymer electrolyte membrane for a fuel cell comprising the polymer electrolyte according to claim 8.

10. The polymer electrolyte membrane according to claim 9, a weight decrease of which is 10% or less after an immersion in water, N-methylpyrrolidone, dimethylacetamide, dimethylformamide, dimethyl sulfoxide, ethanol, methanol or a mixture thereof at 80° C. for 24 hours, comparing with its weight before the immersion.

11. A membrane electrode assembly comprising the polymer electrolyte membrane according to claim 9, a cathode electrode, and an anode electrode, wherein the polymer electrolyte membrane is interposed between the cathode electrode and the anode electrode.

12. A fuel cell comprising the membrane electrode assembly according to claim 11.
